(19) United States
(12) Patent Application Publication
(10) Pub. No.: US 2013/0016775 A1
(43) Pub. Date: Jan. 17, 2013

(54) Video Encoding Using Visual Quality Feedback

(71) Applicants: David Prakash Varodayan, Stanford, CA (US); Wai-Tian Tan, Sunnyvale, CA (US)

(72) Inventors: David Prakash Varodayan, Stanford, CA (US); Wai-Tian Tan, Sunnyvale, CA (US)

(21) Appl. No.: 13/179,789

(22) Filed: Jul. 11, 2011

(51) Int. Cl. H04N 7/26

(52) U.S. Cl. 375/240.05; 375/240.07; 375/E07.126

(57) ABSTRACT

Video quality is improved by encoding video frames based on visual quality feedback received from recipients about decoded video. A video frame is encoded based on whether a previous decoded video frame comprises a severe degradation.

### BACK GROUND

As the Internet gains popularity, more and more services and videos become available online, inviting users to share or consume videos over the Internet, Due to factors such as network congestion and faulty networking hardware, packets containing video data may become lost (or dropped) during transmission, causing the video quality at the recipient side to suffer. Because videos typically are encoded in a motion-compensated predictive manner, when a packet containing a segment of a video frame is lost, errors can propagate spatiotemporally in later frames. The existing solution for mitigating impacts of packet losses in video streams involves encoding subsequent video frames using intra-frame coding whenever a packet loss is detected, which is undesirable because it requires substantial network bandwidth and causes substantial delay to the video transmission. Accordingly, there is a need for a way to efficiently handle packet losses in video streaming.

### BRIEF DESCRIPTION OF THE DRAWINGS

FIG. 1 is a diagram of an embodiment of an architecture for a system that adaptively encodes video streams based on visual quality feedback.

FIG. 2 is a diagram of an embodiment of a projection scheme used in the system shown in FIG. 1.

FIG. 3 is a diagram of an embodiment of a block structure used in the system shown in FIG. 1.

FIGS. 4 and 5 are diagrams of an embodiment of a method for the system shown in FIG. 1 to adaptively encode video streams based on visual quality feedback.

FIG. 6 is a diagram of an example of a computer system.

### DETAILED DESCRIPTION

The present subject matter is now described more fully with reference to the accompanying figures, in which several embodiments of the subject matter are shown. The present subject matter may be embodied in many different forms and should not be construed as limited to the embodiments set forth herein. Rather these embodiments are provided so that this disclosure will be complete and will fully convey principles of the subject matter.

### Example System Architecture

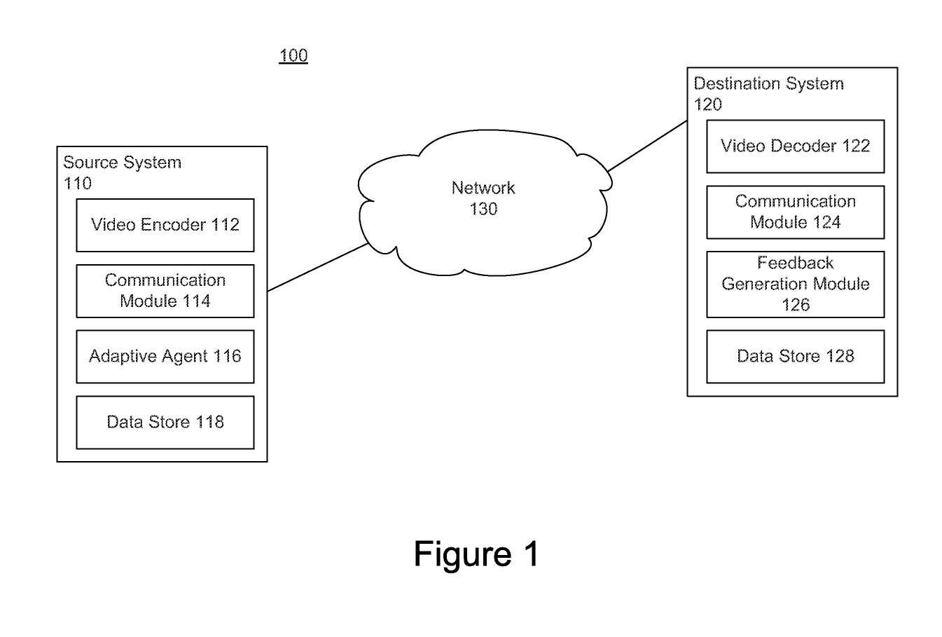

FIG. 1 illustrates one embodiment of a system architecture for an error resilient video transportation system 100 that adaptively encodes video streams based on visual quality feedback from recipients. The error resilient video transportation system 100 includes a source system 110 and a destination system 120 connected through a network 130. Only one of each type of entity is illustrated for clarity.

The source system 110 encodes video into a video stream, and transmits the video stream to the destination system 120. The destination system 120 decodes the video stream to reconstruct the video, and displays the decoded video. In addition, the destination system 120 applies a projection scheme to decoded video frames to generate visual symbols characterizing blocks in the decoded video frames, and transmits the visual symbols to the source system 110 as visual quality feedback signals. The source system 110 applies the same projection scheme to the original (or error-free) video frames to generate a set of local visual symbols, and compares the two sets of visual symbols to detect unacceptably visually degraded blocks (e.g., blocks containing visually noticeable degradations, also called the “severely degraded blocks”) in the decoded video frames, and adaptively controls the encoding of subsequent video frames to improve the quality of the decoded video.

The source system 110 is a computer system that includes a video encoder 112, a communication module 114, an adaptive agent 116, and a data store 118. The video encoder 112 (e.g., a H.264/AVC (Advanced Video Coding) encoder) encodes a sequence of video frames into a video stream (e.g., a bit stream). The video encoder 112 supports multiple encoding schemes (e.g., inter-frame coding, intra-frame coding, intra-slice coding, intra-block coding, and reference picture selection), and can selectively encode a video flume or a region of the video frame using one of the supported encoding schemes based on inputs from the adaptive agent 116. The communication module 114 packetizes the video stream into packets and transmits the packets to the destination system 120 through the network 130. In addition, the communication module 114 receives packets from the destination system 120 containing visual quality feedback signals, de-packetizes (or reconstructs) the visual quality feedback signals, and provides the reconstructed visual quality feedback signals to the adaptive agent 116.

The adaptive agent 116 generates local visual symbols characterizing original video frames or error-free video frames. An original video frame is a frame in the original video as received by the video encoder 112 (e.g., a high-definition color video sequence with a resolution of 704×1280 pixels and a frame rate of 30 Hz generated by a video camera connected to the source system 110). An error-free video frame is a frame in the video stream as encoded by the video encoder 112 without errors introduced during transmission (e.g., packet losses). To generate a local visual symbol for a color video frame, the adaptive agent 116 converts the color video frame to a black-and-white grayscale video frame, divides the grayscale video frame into blocks of pixels (e.g. 64×64 blocks of pixels), and applies a projection scheme to each block to generate a projection coefficient that characterizes the block. A projection scheme is a dimensionality-reducing operation. Example projection schemes include a mean projection, a horizontal difference projection, and a vertical different projection.

The mean projection is designed to characterize significant distortions within a frame. For a block of pixels, the projection coefficient of the mean projection is the mean value of the luminance values (the “luma values”) of the pixels in the block.

The horizontal difference projection is designed to characterize errors such as horizontal misalignment errors e.g., caused by frame copy under horizontal motion). To calculate the projection coefficient of the horizontal difference projection for a 64×64 block of pixels, that block is divided into a left and a right sub-block, each of size 64×32 pixels, the mean value of the luma values of the pixels in the left sub-block (the “left mean value”) and the mean value of the luma values of the pixels in the right sub-block (the “right mean value”) are calculated, and the right mean value is subtracted from the left mean value to obtain the projection coefficient.

The vertical different projection is designed to characterize errors such as vertical misalignment errors (e.g., caused by frame copy under vertical motion). To calculate the projection coefficient of the vertical difference projection for a 64×64 block of pixels, that block is divided into a top and a bottom sub-block, each of size 32×64 pixels, the mean value of the luma values of the pixels in the top sub-block (the “top mean value”) and the mean value of the luma values of the pixels in the bottom sub-block (the “bottom mean value”) are calculated, and the bottom mean value is subtracted from the top mean value to obtain the projection coefficient.

The adaptive agent 116 quantizes the projection coefficients of blocks in a video frame into quantized values (the “quantized symbols”) with respect to a quantization step size. To further reduce the size of the quality feedback signal, a predetermined set of bits e.g., the 3 least significant bits) are extracted from the quantized symbols to collectively form a visual symbol for that video frame. In one example, the quantization step size for the mean projection ranges from 2⁵ to 2⁻¹ (e.g., 2³) and the quantization step sizes for the horizontal difference projection and the vertical different projection range from 2⁴ to 2⁻² (e.g., 2⁻²).

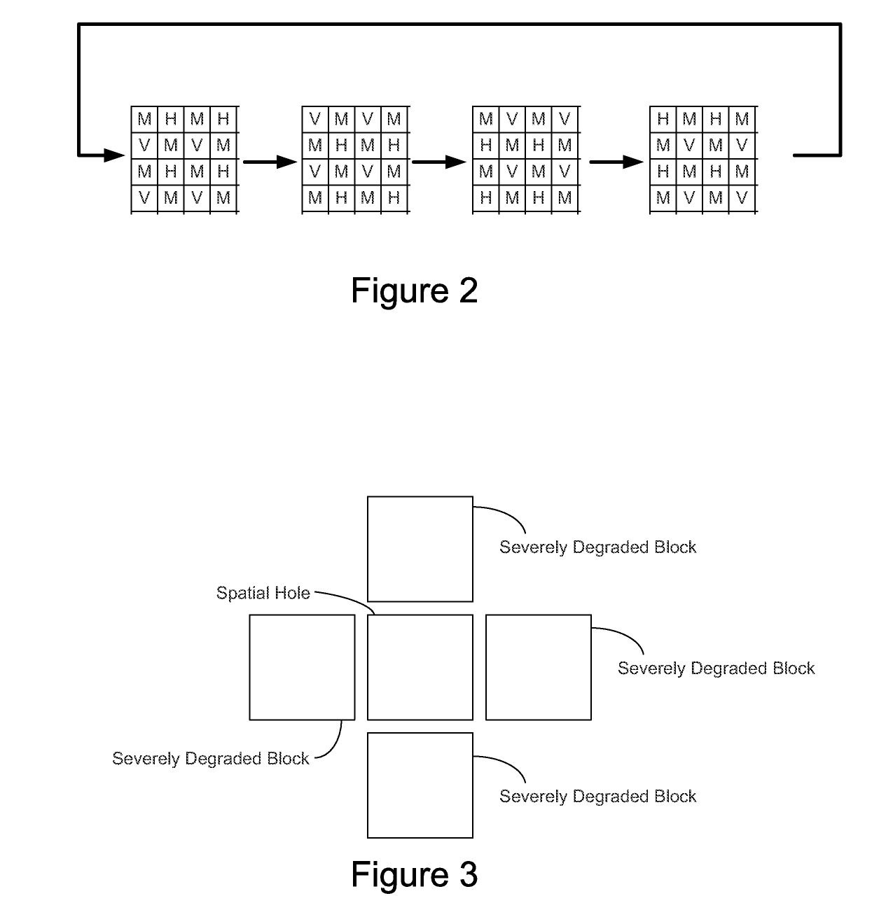

It is observed that the effectiveness of the three projections in detecting severely degraded blocks varies depending on the target video content: the mean projection functions better for video sequences with flat regions (e.g., regions with little or no image characteristics such as edges, textures, or the like); the horizontal projection functions better for sequences with texture and horizontal motion; and the vertical projection functions better for sequences with texture and vertical motion. In response to this observation, in one example, the adaptive agent 116 applies a combined projection scheme to generate visual symbols. In the combined projection scheme, one of the three projections is chosen for each block according to its spatiotemporal position in the video sequence. FIG. 2 shows the patterns of projections that cycle every 4 frames. Within a frame, the pattern of projections resembles the pattern of colors in a Bayer filter, with the mean projection (blocks labeled “M”) occupying one checkerboard color and the horizontal difference projection (blocks labeled “H”) and the vertical difference projection (blocks labeled “V”) sharing the other. As shown, any block will have a projection different from the projections of its adjacent neighboring blocks, and different from the projections of the same block in the adjacent frames (i.e., frames immediately before and after).

The adaptive agent 116 detects severely degraded blocks in decoded video frames by comparing the locally generated visual symbols with corresponding visual symbols in the visual quality feedback. Visual symbols in the visual quality feedback are generated by applying the same projection scheme on the decoded video frame as the one applied for generating the local visual symbols. If two visual symbols match, the adaptive agent 116 determines that none of the blocks in the corresponding decoded video frame is severely degraded (i.e., all blocks contain either no degradation or only mild (or unnoticeable) degradations). Otherwise, if any pair of corresponding quantized symbols in the two visual symbols mismatch, the adaptive agent 116 determines that the blocks represented by the mismatching quantized symbols are severely degraded.

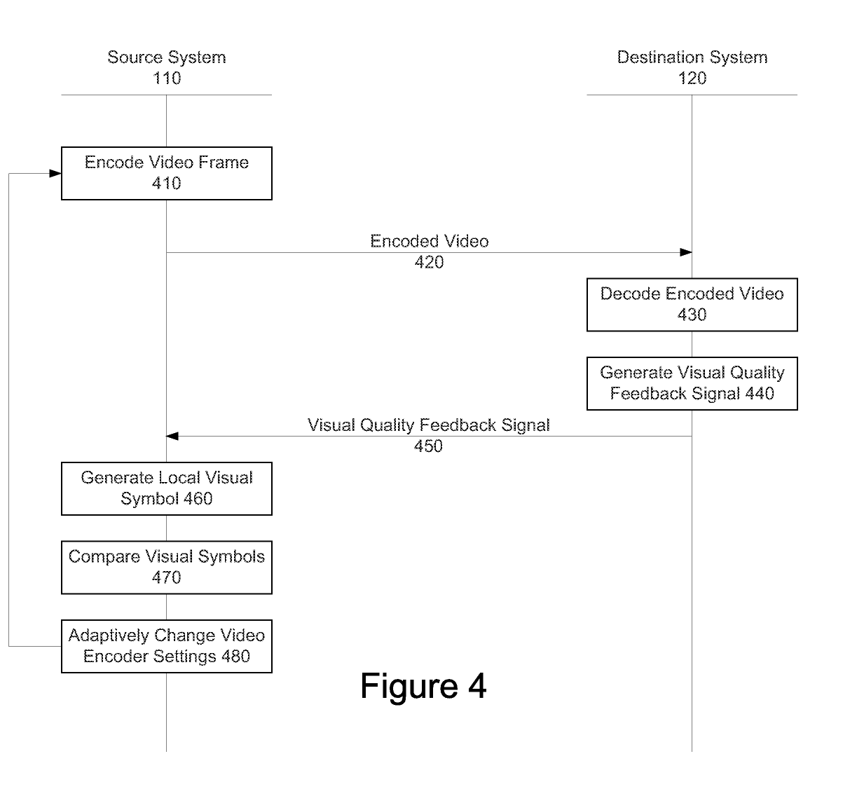

The adaptive agent 116 generates a degradation map (e.g., a bitmap) for a decoded video frame and marks blocks that are determined severely degraded as severely degraded in map. The remaining blocks are marked not severely degraded, a term which encompasses un-degraded and mildly degraded. In one example, if a block is marked as not severely degraded in the degradation map and is surrounded by adjacent neighboring blocks marked as severely degraded, the adaptive agent 116 marks the surrounded block (the “spatial hole”) as severely degraded. It is Observed that severe video degradations are commonly caused by packet losses which are typically caused by congestion and do not occur randomly, and the error propagations caused by packet losses tend to be spatially coherent. Thus, the spatial holes are more likely to contain severe visual degradations comparing to other blocks marked not severely degraded. This treatment of the spatial holes is further justified when the combined projection scheme is applied, because different projections are applied to the surrounded block and the adjacent neighboring blocks in the combined projection scheme, and the degradation in the blocks may happen to be undetected by the projection applied to the surrounded block (the spatial hole) and detected by the projection(s) applied to the adjacent neighboring blocks. The spatial holes can be tilled by applying binary morphological operations in the degradation map. Specifically, the adaptive agent 116 dilates and then erodes the degradation map with the cross-shaped structuring element shown in FIG. 3, and thereby switches the marking of blocks surrounded by severely degraded blocks from not severely degraded to severely degraded.

The adaptive agent 116 corrects severe visual degradations detected in decoded video by adaptively changing video encoder settings for encoding subsequent video frames. If any block in a decoded video frame is marked severely degraded, the adaptive agent 116 controls the video encoder 112 to take corrective encoding actions for subsequent video frames. One example of corrective encoding action is performing costly corrective encoding schemes (e.g., intra-frame coding, intra-slice coding, intra-block coding and reference picture selection) only on parts of the next video frame (e.g., the degraded blocks or surrounding larger regions) without referencing the degraded blocks (or the video frame containing the degraded blocks). Alternatively or additionally, the adaptive agent 116 may control the video encoder 112 to apply a corrective encoding scheme to the next video frame without referencing the degraded block or the video frame containing the degraded blocks (e.g., when the video encoder 112 does not have the capacity to apply multiple encoding schemes in a video frame). The adaptive agent 116 may also control the video encoder 112 to remove the degraded blocks (or surrounding larger regions, the video frame containing the degraded blocks) from the prediction buffer of the video encoder 112. By performing a corrective action soon after a severe degradation is detected, the video encoder 112 may mitigate the propagation of that degradation. If all blocks in a decoded video frame are marked not severely degraded, then the adaptive agent 116 can choose not to take any corrective action for the next video frame, and instead rely on the destination system 120 to apply error resilient techniques to correct any degradation in that video frame.

The data store 118 stores data used by the source system 110. Examples of the data stored in the data store 118 include original video frames, error-free video frames, visual symbols generated for the original or error-free video frames, received visual quality feedback, and information about the video encoder 112. The data store 118 may be a database stored on a non-transitory computer-readable storage medium.

The destination system 120 is a computer system that includes a video decoder 122, a communication module 124, a feedback generation module 126, and a data store 128. The communication module 124 receives from the source system 110 through the network 130 packets containing video data, de-packetizes the received packets to reconstruct the video stream. In addition, the communication module 124 packets visual quality feedback signals provided by the feedback generation module 126 and transmits the packets to the source system 110. The decoder decodes the video stream into a sequence of video frames, and displays the decoded video frames. Due to factors such as network congestion and faulty networking hardware, packets containing video data may become lost during transmission, causing errors in the decoded video stream. To mitigate damages caused by these factors, the destination system 120 applies error resilient techniques such as error concealment (e.g., frame copy) to the decoded video frames.

The feedback generation module 126 obtains the decoded video frames (e.g., by calling functions supported by the video decoder 122), and generates visual symbols for the decoded video frames by applying the same projection scheme on the decoded video frame as the one the adaptive agent 116 applied for generating the local visual symbols. Even though the video decoder 122 decodes the video stream using various error resilient techniques, there still may be severe degradation in the decoded video frames. The feedback generation module 126 works with the communication module 124 to transmit the visual symbols to the source system 110 as visual quality feedback signals about the decoded video frames, such hat the source system 110 can prevent further error propagation by taking corrective actions to encode subsequent video frames to be sent to the destination system 120 based on the visual quality feedback signals. In one example, to prevent the visual quality feedback signals from suffering error propagation caused by packet tosses containing the visual quality feedback signals, the communication module 124 does not perform inter-frame compression for the visual quality feedback signals.

The network 130 is configured to connect the source system 110 and the destination system 120. The network 130 may be a wired or wireless network. Examples of the network 130 include the Internet, an intranet, a WiFi network, a WiMAX network, a mobile telephone network, or a combination thereof.

### Example Processes

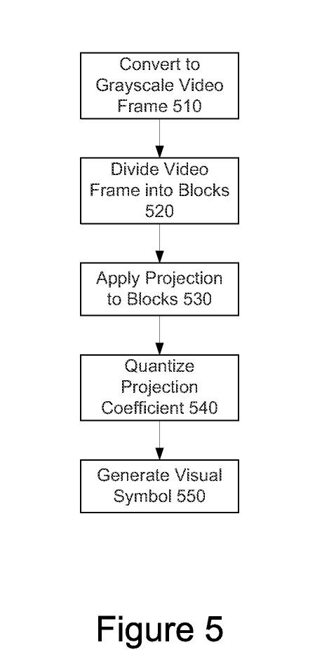

FIGS. 4-5 are flow diagrams that collectively show an embodiment of a method for the error resilient video transportation system 100 to adaptively encode video streams based on visual quality feedback from recipients. Other embodiments perform the steps in different orders and/or perform different or additional steps than the ones shown.

Referring to FIG. 4, the source system 110 encodes 410 a video frame (the “original video frame”) in a video into a video stream, and transmits 420 the video stream to the destination system 120. The destination system 120 decodes 430 the received encoded video stream to reconstruct the video frame (the “decoded video frame”). Due to factors such as network congestion and faulty networking hardware, packets containing the video stream may become lost during transmission, causing video quality of the decoded video frame to degrade. The destination system 120 may apply error resilient techniques such as error concealment to ameliorate, but serious visual quality degradations may occur in the decoded video frame nonetheless. The destination system 120 generates 440 a visual quality feedback signal containing a visual symbol characterizing the decoded video frame, and transmits 450 the signal to the source system 110.

Referring now to FIG. 5, a flow diagram illustrating a process for the destination system 120 to generate a visual symbol. The destination system 120 converts 510 the decoded video frame to a grayscale video frame and divides 520 the grayscale video frame into blocks of pixels (e.g., 64×64 blocks of pixels). For each block, the destination system 120 applies 530 a projection (e.g., the mean projection, the horizontal difference projection, or the vertical different projection) according to a projection scheme (e.g., the combined projection scheme) to the block to generate a projection coefficient, and quantizes 540 the projection coefficient into a quantized symbol with respect to a quantization step size (e.g., 2³ for the mean projection, and 2⁻² for the horizontal difference projection and the vertical different projection). The destination system 120 generates 550 the visual symbol by combining the quantized symbols (or a predetermined set of bits (e.g., the 3 least significant bits) extracted from the quantized symbols).

Referring back to FIG. 4, the source system 110 generates 460 a local visual symbol for the original video frame (or the corresponding error-free video frame) the same manner as the destination system 120 did for generating the visual symbol in the received visual quality feedback signal. The source system 110 can generate the local visual symbol in advance (e.g., when the original video frame is encoded) or after receiving the visual quality feedback signal. The source system 110 compares 470 the local visual symbol with the received visual symbol and, if any pair of corresponding quantized symbols in the two visual symbols mismatch, determines that the blocks represented by the mismatching quantized symbols are severely degraded in the decoded video frame.

The source system 110 corrects severe visual degradations in the decoded video by adaptively changing 480 video encoder settings for encoding 410 subsequent video frames using corrective encoding actions such as encoding regions including the degraded blocks without referencing the degraded blocks in the decoded video frame, and transmits 420 the adaptively encoded video frames to the destination system 120. If none of the blocks in the decoded video frame is determined severely degraded, then the source system 110 chooses not to take any corrective action for the next video frame, and instead rely on the destination system 120 to apply error resilient techniques to correct degradations f an). Steps 410 through 480 repeat as the destination system 120 continues to provide visual quality feedback signals for subsequent decoded video frames, and the source system 110 continues to use the visual quality feedback signals to track and correct severe degradations in the decoded video.

### Additional Applications

The described implementations have broad applications. For example, the implementations can be used to adaptively improve visual quality in a live multicast system, where one live encoded video stream is distributed to multiple destination systems. As another example, the implementations can be used to improve visual quality in a video conference system, where multiple systems exchange live video streams. In these applications, a source system may receive visual quality feedback signals from multiple destination systems. The source system generates one degradation map for each destination system, combines the degradation maps into a single degradation map marking severely degraded blocks identified for a video frame in any of the signals, and adaptively encodes subsequent video frames based on the combined degradation map. In one embodiment, techniques such as Slepian-Wolf coding are applied to the visual quality feedback signals to reduce overhead and/or improve reliability.

The described implementations may enable video sources to take corrective actions only when necessary. By constantly tracking the visual quality of the decoded video, a video source may decide not to act on non-substantial degradations, and only to selectively take corrective actions in certain regions when severe degradations take place in such regions, and thereby improves system performance. In addition, the overhead for the visual quality feedback signals may be low. In an experiment of a live multicast system involving 20 clients, the overhead of the visual quality feedback is about 1% of the video stream, while the visual quality feedback contains sufficient information for the source system to detect severely degraded blocks in the decoded video. The described implementations may be conveniently integrated into existing systems since the adaptive agent 116 and the feedback generation module 126 may be configured to work with existing video encoders/decoders.

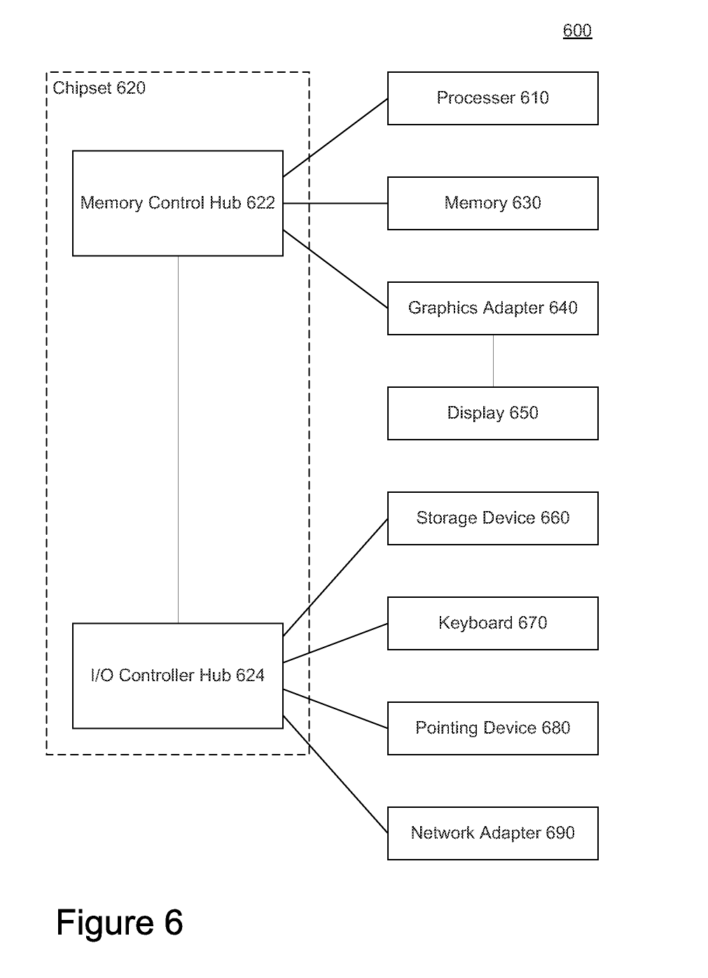

In one example, the entities shown in FIGS. 1 and 4 are implemented using one or more computer systems. FIG. 6 is a high-level block diagram illustrating an example computer system 600. The computer system 600 includes at least one processor 610 coupled to a chipset 620. The chipset 620 includes a memory controller hub 622 and an input/output (I/O) controller hub 624. A memory 630 and a graphics adapter 640 are coupled to the memory controller hub 622, and a display 650 is coupled to the graphics adapter 640. A storage device 660, a key-board 670, a pointing device 680, and a network adapter 690 are coupled to the I/O controller hub 624. Other embodiments of the computer system 600 have different architectures.

The storage device 660 is a non-transitory computer-readable storage medium such as a hard drive, compact disk read-only memory (CD-ROM), DVD, or a solid-state memory device. The memory 630 holds instructions and data used by the processor 610. The pointing device 680 is a mouse, track ball, or other type of pointing device, and is used in combination with the keyboard 670 to input data into the computer system 600. The graphics adapter 640 displays images and other information on the display 650. The network adapter 690 couples the computer system 600 to one or more computer networks.

The computer system 600 is adapted to execute computer program modules for providing functionality described herein. As used herein, the term “module” refers to computer program logic used to provide the specified functionality. Thus, a module can be implemented in hardware, firmware, and/or software. In one embodiment, program modules are stored on the storage device 660, loaded into the memory 630, and executed by the processor 610.

The types of computer systems 600 used by entities can vary depending upon the embodiment and the processing power required by the entity. For example, a source system 110 might comprise multiple blade servers working together to provide the functionality described herein. As another example, a destination system 120 might comprise a mobile telephone with limited processing power. A computer system 600 can lack some of the components described above, such as the keyboard 670, the graphics adapter 640, and the display 650.

One skilled in the art will recognize that the configurations and methods described above and illustrated in the figures are merely examples, and that the described subject matter may be practiced and implemented using many other configurations and methods. It should also be noted that the language used in the specification has been principally selected for readability and instructional purposes, and may not have been selected to delineate or circumscribe the inventive subject matter. Accordingly, the disclosure of the described subject matter is intended to be illustrative, but not limiting, of the scope of the subject matter, which is set forth in the following claims.

What is claimed is:

1. A method for improving video quality using visual quality feedback, comprising:
encoding a first video frame into a video stream;
transmitting to a destination system a plurality of packets containing the video stream;
receiving from the destination system a visual symbol for a decoded video frame, the decoded video frame being decoded from at least a portion of the plurality of packets;
generating a local visual symbol based on the first video frame;
determining whether the decoded video frame comprises a severe degradation by comparing the received visual symbol with the local visual symbol; and
encoding a second video frame based on whether the decoded video frame is determined to comprise a severe degradation.

2. The method of claim 1, wherein generating the local visual symbol comprises:
generating symbols for a plurality of regions in the first video frame; and
generating the local visual symbol to include at least a portion of the symbols for the plurality of regions.

3. The method of claim 2, wherein determining whether the decoded video frame comprises severe degradation comprises:
determining that a region in the first video frame comprises a severe degradation responsive to a symbol for the region in the local visual symbol mismatches a symbol for the region in the received visual symbol.

4. The method of claim 3, wherein encoding the second video frame comprises:
encoding the region in the second video frame without referencing the region in the first video frame.

5. The method of claim 2, wherein different projections are applied to adjacent regions in the first video frame, and wherein generating the local visual symbol further comprises:
applying a projection to one of the plurality of regions to generate a projection coefficient; and
quantizing the projection coefficient with a quantization step size to generate a symbol for said region.

6. The method of claim 1, wherein generating the local visual symbol comprises generating the local visual symbol based on a video frame in the video stream corresponding to the first video frame.

7. The method of claim 1, further comprising:
responsive to a determination that the decoded video frame is free of severe degradation, encoding the second video frame without applying a corrective encoding scheme.

8. A non-transitory computer-readable storage medium having computer program instructions recorded thereon for improving video quality using visual quality feedback, the computer program instructions comprising instructions for:
encoding a first video frame into a video stream;
transmitting to a destination system a plurality of packets containing the video stream;
receiving from the destination system a visual symbol for a decoded video frame, the decoded video frame being decoded from at least a portion of the plurality of packets;
generating a local visual symbol based on the first video frame;
determining whether the decoded video frame comprises a severe degradation by comparing the received visual symbol with the local visual symbol; and
encoding a second video frame based on whether the decoded video frame is determined to comprise a severe degradation.

9. The storage medium of claim 8, wherein generating the local visual symbol comprises:
generating symbols for a plurality of regions in the first video frame; and
generating the local visual symbol to include at least a portion of the symbols for the plurality of regions.

10. The storage medium of claim 9, wherein determining whether the decoded video frame comprises severe degradation comprises:
determining that a region in the first video frame comprises a severe degradation responsive to a symbol for the region in the local visual symbol mismatches a symbol for the region in the received visual symbol.

11. The storage medium of claim 10, wherein encoding the second video frame comprises:
encoding the region in the second video frame without referencing the region in the first video frame.

12. The storage medium of claim 9, wherein different projections are applied to adjacent regions in the first video frame, and wherein generating the local visual symbol further comprises:
applying a projection to one of the plurality of regions to generate a projection coefficient; and
quantizing the projection coefficient with a quantization step size to generate a symbol for said region.

13. The storage medium of claim 8, wherein generating the local visual symbol comprises generating the local visual symbol based on a video frame in the video stream corresponding to the first video frame.

14. The storage medium of claim 8, wherein the computer program instructions further comprises instructions for:
responsive to a determination that the decoded video frame is free of severe degradation, encoding the second video frame without applying a corrective encoding scheme.

15. A method for generating visual quality feedback for improving video quality, comprising:
receiving from a video source a first plurality of packets containing a video stream;
decoding the encoded video data into a decoded video frame;
generating a visual symbol based on the decoded video frame;
transmitting to the video source the visual symbol as a visual quality feedback signal; and
receiving from the video source a second plurality of packets containing a second video stream encoded based at least in part on the visual symbol.

16. The method of claim 15, wherein generating the visual symbol comprises:
generating symbols for a plurality of regions in the decoded video frame; and
generating the visual symbol to include at least a portion of the symbols for the plurality of regions.

17. The method of claim 16, wherein generating the visual symbol further comprises:
applying a projection to one of the plurality of regions to generate a projection coefficient; and
quantizing the projection coefficient with a quantization step size to generate a symbol for said region.

18. The method of claim 17, wherein different projections are applied to adjacent regions in the decoded video frame.

19. The method of claim 18, further comprising:
applying a different projection to said region in another decoded video frame.

20. The method of claim 15, further comprising:
converting the decoded video frame into a grayscale video frame,
wherein generating the visual symbol comprises generating the visual symbol based on the grayscale video frame.
